(19) United States
(12) Patent Application Publication
(10) Pub. No.: US 2024/0017998 A1
(43) Pub. Date: Jan. 18, 2024

(54) METHOD OF PRODUCING SINGLE CRYSTALLINE BORON NITRIDE NANOSHEETS AND BORON CARBON NITRIDE NANOSHEETS

(71) Applicant: THE ROYAL INSTITUTION FOR THE ADVANCEMENT OF LEARNING/MCGILL UNIVERSITY, Montréal (CA)

(72) Inventors: Aqeel ALREBH, Montréal (CA); Jean-Luc MEUNIER, Montreal (CA)

(21) Appl. No.: 18/252,728

(22) PCT Filed: Nov. 10, 2021
(86) PCT No.: PCT/CA2021/051601

§ 371 Date: May 12, 2023

(51) Int. Cl. C01B 21/064; B82Y 30/00; B82Y 40/00

(52) U.S. Cl. CPC C01B 21/0641; B82Y 30/00; B82Y 40/00; C01P 2004/20

(57) ABSTRACT

There is provided a method for producing SC-BNNS and SC-BCNNS. A thermal plasma is provided at a plasma zone of a reaction chamber having an outlet opposite the plasma zone, a condensation zone and a growth zone downstream. The gas flows in the chamber have a laminar flow which provides a controlled residence time in a nucleation temperature field. A plasma-source gas flow is provided and has a plasma-source gas, and a sheath gas flow including nitrogen-containing gas to provide an excess of nitrogen. A boron source is provided to the thermal plasma through a probe to provide boron atomic species. A carbon source is provided for the production of SC-BCNNS. The process includes a controlled quenching step in the condensation zone followed by two-dimensional nucleation of SC-BNNS or SC-BCNNS in the growth zone, and the pressure in the chamber is maintained between 20 to 200 kPa.

### TECHNICAL FIELD

This disclosure relates to the field of single crystalline boron nitride nanosheet (SC-BNNS) and single crystalline boron carbon nitride nanosheets (SC-BCNNS) production, and particularly to a scalable SC-BNNS and SC-BCNNS production.

### BACKGROUND OF THE ART

Boron nitride nanosheets have been produced by various methods such as chemical vapor deposition (CVD) and pulsed laser deposition (PLD). Plasma enhanced chemical vapor deposition (PECVD) has been used with epitaxial growth for generating vertically aligned boron nitride nanosheets (BNNS) films on various types of substrates. Free-standing BNNS have also been synthesized through batch processes like ball milling, ultrasonic exfoliation, unzipping of boron nitride nanotubes (BNNT), pyrolysis, chemical blowing and by the micro-fluidization techniques. Unfortunately, these techniques have some common drawbacks that limit harnessing advantages BNNS may have in many of the prospective applications. For example, they (i) generate free-standing BNNS or single crystalline BNNS (SC-BNNS) of a low quality, (ii) require catalysts, (iii) are time-consuming, and/or (iv) involve contaminants and/or solvents, examples being ball milling and ultrasonic exfoliation. Moreover, when free-standing BNNS are produced according to the methods of the prior art, the BNNS will have low crystallinity or produce thicker and larger nanosheets which are undesirable for many applications. To fully utilize BNNS, it is particularly important to produce single crystalline BNNS which are few-layered, and have smaller spatial sizes in their 2-dimensional planar directions.

Recently, the production of boron nitride nanotubes (BNNTs) has been described in US20170197832 (Fathalizadeh et al) and US20170253485A2 (Kim et al). However, although the chemical composition of BNNTs is similar to that of BNNS, the nanostructure greatly differs and the BNNT methods does not prove to produce single crystalline BNNS. Indeed, both Fathalizadeh et al and Kim et al demonstrate a method for the controlled production of BNNTs, and Fathalizadeh et al also indicates boron nitride nanoribbons generated from flattened BNNTs. However, these two materials are one-dimensional and quasi-one dimensional nanostructures respectively with very high aspect ratios in contrast with SC-BNNS which are two-dimensional structures with a lower aspect ratio. BNNS are not produced by these two methods. Further, the two methods of Fathalizadeh et al and Kim et al do not show the possibility of synthesizing single crystalline boron nitride nanosheets (SC-BNNS), these two methods generating rather the 1-dimentional BNNT structures.

On the other hand, graphene nanosheets have a similar nanostructure with wholly different chemistries compared to SC-BNNS. Advancements in the field of graphene nanosheets, such as U.S. Ser. No. 10/329,156, do not translate to the field of BNNS due to very different and often opposite physicochemical and optical properties. The lack of processes that result in highly crystalline BNNS, having limited-layers, small and controllable in-plane sizes, and made readily available in scalable quantities in a powder form remain elusive.

Two-dimensional boron carbon nitride nanosheets (BCNNS) are ternary advanced materials composed of B, C, and N atoms having hexagonal a structure resembling that of graphene nanosheets and boron nitride nanosheets. Along the plane of a BCNNS sheet, the atoms are in an sp²-hypridized bonding. Compared to graphene and BNNS, BCNNS have strong interlayer interactions but an inferior in-plane stability caused by the tendency of B—N and C—C bonds to segregate. However, the conventional top-down methods used for graphene and BNNS synthesis are usually not effective for generating BCNNS due to their relatively low in-plane stability. A few bottom-up techniques have demonstrated the capability of fabricating BCNNS and thin BCN films such techniques include the catalytic chemical vapour deposition (CVD) method, the molten salt assembly growth technique, laser pulse deposition and magnetron sputtering. These techniques require catalysts or substrates, produce various contaminants (such as oxygen) and by-products and yields poor BCNNS morphology. There is thus a need to improve the quality and scalability of SC-BNNS and BCNNS production such that these materials become cost effective for real-life applications and in industrial settings.

### SUMMARY

In one aspect there is provided a method for producing single crystalline boron nitride nanosheet. A thermal plasma is provided at a plasma zone of a reaction chamber, the reaction chamber having an outlet opposite the plasma zone, a condensation zone and a growth zone downstream of the thermal plasma, wherein gas flows have a laminar flow in the reaction chamber wherein the laminar flow provides a controlled residence time in a nucleation temperature field. The pressure in the reaction chamber is between 20 to 200 kPa. A plasma-source gas flow is provided comprising a plasma-source gas for the thermal plasma, and a sheath gas flow at the plasma zone of the reaction chamber comprising nitrogen-containing gas to provide an excess of nitrogen in the reaction chamber. A boron source is provided to the thermal plasma through a probe into the thermal plasma to provide boron. The boron thus reacts with the nitrogen to form the single crystalline boron nitride nanosheets, the reaction comprising quenching in the condensation zone followed by two-dimensional nucleation downstream in the growth zone.

In one embodiment, the method further comprises providing a carbon precursor before the step of reacting to obtain single crystalline boron carbon nitride nanosheets (SC-BCNNS).

In one aspect there is provided a method for producing single crystalline boron carbon nitride nanosheet. A thermal plasma is provided at a plasma zone of a reaction chamber, the reaction chamber having an outlet opposite the plasma zone, a condensation zone and a growth zone downstream of the thermal plasma, wherein gas flows have a laminar flow in the reaction chamber wherein the laminar flow provides a controlled residence time in a nucleation temperature field. The pressure in the reaction chamber is between 20 to 200 kPa. A plasma-source gas flow is provided comprising a plasma-source gas for the thermal plasma, and a sheath gas flow at the plasma zone of the reaction chamber comprising nitrogen-containing gas to provide an excess of nitrogen in the reaction chamber. A carbon source is provided to the reaction chamber to provide atomic carbon. A boron source is provided to the thermal plasma through a probe into the thermal plasma to provide atomic boron. The boron thus reacts with the nitrogen and carbon to form the single crystalline boron carbon nitride nanosheets, the reaction comprising quenching in the condensation zone followed by two-dimensional nucleation downstream in the growth zone.

In one embodiment, the carbon precursor is methane.

In one embodiment, the nucleation temperature field is between 2000 to 5000 K.

In one embodiment, the laminar flow is a laminar expansion flow.

In one embodiment, the method further comprises the step of collecting the single crystalline boron nitride nanosheets or the single crystalline boron carbon nitride nanosheets.

In one embodiment, the reaction chamber has a cross sectional surface area that increases downstream from the plasma zone.

In one embodiment, the reaction chamber has a conical geometry.

In one embodiment, the reaction chamber is cylindrical and includes peripheral inlets.

In one embodiment, the boron source is in a solid, liquid, or gaseous state.

In one embodiment, the probe is a cooled probe.

In one embodiment, the cooled probe is a water cooled probe.

In one embodiment, the pressure in the reaction chamber is between 40 to 75 kPa.

In one embodiment, the pressure in the reaction chamber is between 60 to 64 kPa.

In one embodiment, the method further comprises cooling or heating walls of the reaction chamber.

In one embodiment, the plasma-source gas is selected from the group consisting of Ar, He, Ne, Xe, and N₂.

In one embodiment, the boron source is selected from the group consisting of ammonia borane, boron particles, boron carbide, boron trioxide, diborane, boron trichloride and boric acid.

In one embodiment, the thermal plasma is an inductively coupled thermal plasma powered by radio frequency.

In one embodiment, where the method further comprises the step of modifying a residence time in the reaction chamber to control a lateral size and thickness of the single crystalline boron nitride nanosheets or the single crystalline boron carbon nitride nanosheets.

In one embodiment, the method is free of any catalyst.

In one embodiment, the single crystalline boron nitride nanosheets or the single crystalline boron carbon nitride nanosheets have an atomic B:N ratio of between 0.95:1.05 to 1.05:0.95.

In one embodiment, the single crystalline boron nitride nanosheets or the single crystalline boron carbon nitride nanosheets have a thickness of between 1 to 50 atomic layers.

In one embodiment, the single crystalline boron nitride nanosheets or the single crystalline boron carbon nitride nanosheets have a surface area of between 10 to 1500 nm².

In one embodiment, the single crystalline boron nitride nanosheets or the single crystalline boron carbon nitride nanosheets have a crystallinity of at least 95%.

Many further features and combinations thereof concerning the present improvements will appear to those skilled in the art following a reading of the instant disclosure.

### DESCRIPTION OF THE DRAWINGS

FIG. 1 is an atomic model of a layer of boron nitride nanosheets;

FIG. 2A is a schematic cross sectional view of an embodiment of the system with a conical reaction chamber for producing boron nitride nanosheets according to the present disclosure;

FIG. 2B are Computational Fluid Dynamics (CFD) modeled flow lines in the axisymmetric expansion for typical synthesis conditions.

FIG. 2C are eight specific flow lines used for the calculation of the cooling rates of the flowstream between the 5000 K and 3000 K isotherms of FIG. 2B.

FIG. 2D is a schematic of another embodiment of reaction chamber 4 having a cylindrical geometry and top/side gas inlets for a control of the flow streamlines. The net effect of such geometry with gas lines on SC-BNNS synthesis is similar to that of the conical reaction chamber in allowing a removal of recirculating flows;

FIG. 3 is Scanning Electron Microscopy (SEM) micrograph of SC-BNNS powders produced with Ammonia Borane in a thermal plasma. Inset: High magnification SEM of SC-BNNS;

FIG. 4A is a Transmission Electron Microscopy (TEM) image of SC-BNNS with the corresponding Selected Area Electron Diffraction (SAED) pattern;

FIG. 4B is a high resolution TEM image of SC-BNNS showing the single crystalline two-dimensionally oriented atomic planes and the measured interlayer spacing in the inset;

FIG. 5 is Electron Energy Loss Spectra (EELS) for SC-BNNS produced homogenously in Example 1 (top curve) and heterogeneously in Example 2 (bottom curve);

FIGS. 6A and 6B are TEM images of SC-BNNS formed at operating pressures of 48 kPa for FIG. 6A and 75 kPa for FIG. 6B. In 6A, small and thin SC-BNNS are embedded in BNH-based polymeric materials, while in 6B large and thick SC-BNNS are grown on a large boron particle. Insets are magnified versions of the dashed-line square areas;

FIG. 7 is computational fluid dynamic (CFD) calculations showing the evolution of gas axial velocity with respect to the position along the central line inside the reaction chamber, the uninterrupted line corresponds to the conditions set at 10 slpm N₂ and 62 kPa, and the dotted line corresponds to 10 slpm N₂ and 27 kPa;

FIG. 8 is a schematic representation of a possible chemical route for the homogeneous growth of SC-BNNS, where polyaminoborane and polyborazylene represent examples of possible species forming from BₓN_{y}H_{z} intermediates in plasma conditions. Stable nuclei of e.g. polyborazylene represents a particle on which lateral growth takes place to result in SC-BNNS by condensation of active species transported by convection;

FIG. 9 is a schematic representation a possible route for the heterogenous base-growth process of SC-BNNS syntheses in argon-plasma conditions assuming complete melting of B boron particles and abundance of atomic N;

FIGS. 10A-D show SEM micrographs of boron nitride nanosheets synthesized at various operating conditions according to the present disclosure using amorphous boron as a precursor: (10A) thin and wavy SC-BNNS grown vertically on boron particles (conditions: 62 kPa, 10 slpm N₂,); (10B) small SC-BNNS grown vertically on boron particles (27.6 kPa, 10 slpm N₂); (10C) little to no grown BN phase on boron particles (90 kPa, 10 slpm); and (10D) SC-BNNS grown on almost-depleted B particles (62 kPa, 25 slpm N₂); and

FIGS. 11A and 11B are TEM images showing sheet-like structures surrounding boron particles and FIG. 11B is a higher resolution image showing SC-BNNS that seem to originate from the surface of the boron particles. Inset: SAED pattern for the TEM image in 11B.

FIG. 12 is a SEM image of SC-BCNNS.

FIG. 13 is a low resolution TEM image of SC-BCNNS.

FIG. 14 is a high resolution TEM image of the dashed square shown in FIG. 13.

FIG. 15 is an electron energy loss spectroscopy (EELS) spectrum for SC-BCNNS.

### DETAILED DESCRIPTION

Single crystalline Boron nitride nanosheets (SC-BNNS) demonstrate an interesting range of properties. Some of these properties can be similar to those of graphene but some can be completely different such as large energy bandgaps making it a good insulator (i.e. a wide bandgap semiconductor), and excellent thermal and chemical stabilities. Importantly, SC-BNNS may be produced to also have fine-tuned properties such as hydrophobicity. The term “single crystalline” as used herein refers to sheet-like particles each forming one mono-crystal made of superposed and aligned atomic layers. This is in contrast to particles having a large number of defects and misalignments forming a multi-crystalline 2-dimensional sheet structure.

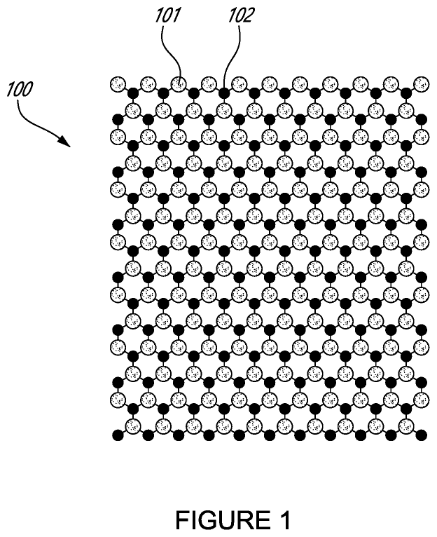

A boron nitride nanosheet is a two dimensional nanomaterial having a low aspect ratio and resembles graphene with alternating boron (B) and nitrogen (N) instead of carbon atoms. Along the plane of a multilayer nanosheet, B₃—N₃ make graphitic hexagons of atoms covalently bonded by sp² strong bonds with an interatomic distance of ˜1.45 Å. FIG. 1 illustrates a single two dimensional crystalline atomic plane 100 formed into hexagonal network of alternating boron atoms 101 and nitrogen atoms 102. A SC-BNNS is formed by the accumulation of one or more of these layers which are held together by Van der Wall-type weak forces with an interlayer spacing of ˜0.34 nm. SC-BNNS, as defined herein, refers to having at least 90%, 95%, 96%, 97%, 98% or 99% of the boron and nitrogen atoms arranged in the nanosheets having a low aspect ratio described herein. Indeed, the present method yields highly pure SC-BNNS substantially free of other types of boron nitride nanostructures.

SC-BNNS display excellent chemical stability, tunable hydrophobicity, strong resistance to thermal oxidation and high thermal conductivity (around 2000 W m⁻¹ K⁻¹). These properties make SC-BNNS well-suited candidates for applications involving automotive and aerospace devices, as well as for protective antioxidation and/or anticorrosion coatings. In addition, SC-BNNS display a wide energy band gap (˜5.5 eV) rendering them electrically nonconductive (wide-bandgap semiconducting) materials, contrasting the electrical properties of graphene. SC-BNNS exhibit ultraviolet photoluminescence which qualifies for applications involving photoelectronic devices, data storage and in the high precision manufacturing industry. Owing to their enhanced biocompatibility and lower toxicity compared to graphene, SC-BNNS are promising materials for biomedical applications such as anticancer drug transport and delivery. In addition, SC-BNNS show exceptional mechanical properties (e.g. elastic modulus ˜850 GPa) and can thus be used as reinforcement agents in applications such as synthetic bone tissues. Furthermore, the polarity of B—N bonds combined with SC-BNNS high surface area also provide a strong affinity as well as a large capacity for adsorbing organic pollutants and contaminants or as an effective storage media for gases like hydrogen.

SC-BCNNS are boron nitride nanosheets doped with carbon (or graphene doped with boron nitride). The boron, carbon and nitrogen atoms are arranged in a hexagonal structure to form a two dimensional planar nanosheet thereby producing a SC-BCNNS layer. As previously mentioned, SC-BCNNS have strong interlayer interactions but have layers with an inferior internal stability when compared to graphene. SC-BCNNS combine the semi-metallic and dielectric properties of graphene (a good electrical conductor) and SC-BNNS (a wide bandgap semiconductor), which renders the SC-BCNNS semiconducting with a tunability of the bandgap characterised by a high degree of freedom. Accordingly, the electrical properties of SC-BCNNS can be optimized based on the atomic ratios of B/C/N present which can result in various band-gap values ranging from 0 eV (for pure graphene) to 5.5 eV (for pure boron nitride). By doping SC-BNNS with carbon, a SC-BCNNS that can act as a semiconductor is obtained. The semiconductor has a wide tunable bandgap that can be modified by changing the C concentration. SC-BNNS are dielectric materials whereas graphene is conductive. Therefore, SC-BCNNS provides useful electrical properties that are not obtained with these other two types of nanosheets. SC-BCNNS are useful in a variety of semiconductor applications since the bandgap can be tuned to the particular application needed. Uses of SC-BCNNS can be the same as the uses for SC-BNNS but will however require optimizing the bandgap of SC-BCNNS to be tailored to the specific application in question. SC-BCNNS in their powder form can be used for paints having specific electronic properties. For example, (i) paints that could act as solar collectors for energy harvesting applications. Bandgap matching could be optimized for solar radiation for example, or infrared radiation from heat sources; (ii) paints having electrochemical interaction in a fluid, potentially mitigating corrosion problems, (iii) composite structure or paints that can sustain very high temperatures, similar to SC-BNNS, but with an electronic component (example: thermo-electric current generation, transferring a cooling surface into an energy generating surface). The ability to adjust the bandgap means a possibility to adjust the material to the temperature in the specific cooling process, enhancing the efficiency. Additional examples include (iv) biomedical applications and (v) SC-BNNS and SC-BCNNS can both be useful to replace boron nitride nanotubes in composites for space applications. In fact, a mix of SC-BNNS and SC-BCNNS could provide specificity to radiation shielding. Further applications for SC-BCNNS include but are not limited to hydrogen storage, energy storage and conversion, wastewater purification, water splitting, CO₂ reduction and other areas, adsorption of harmful pollutants owing to their additional merits such as good thermal and chemical stability, high specific surface area, relatively low cost and little secondary pollution, and finally electronic devices thanks to their ferromagnetic properties.

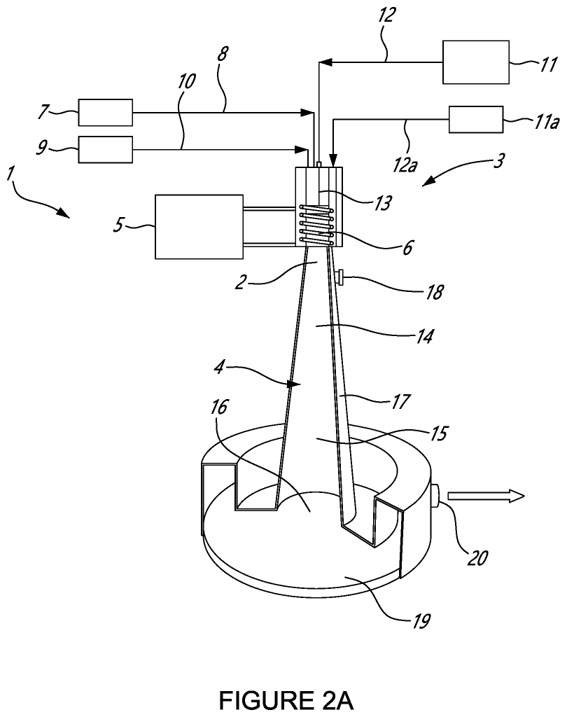

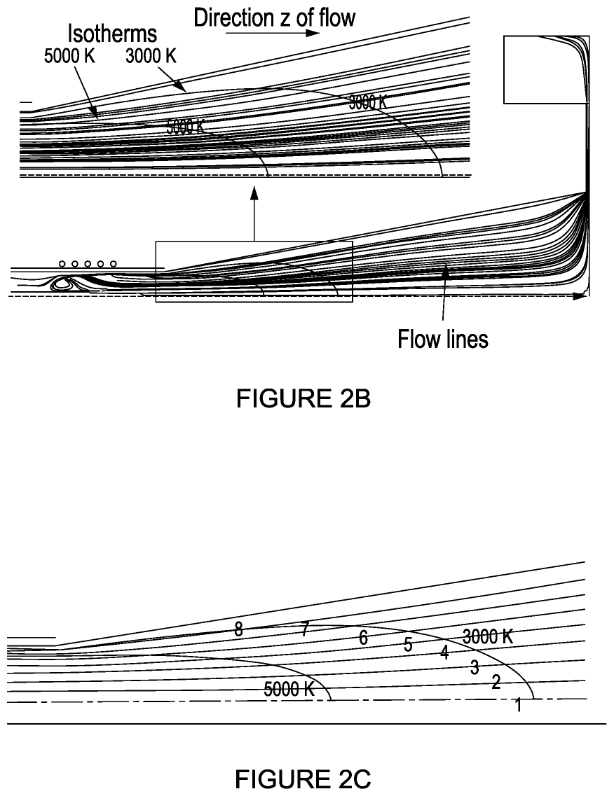

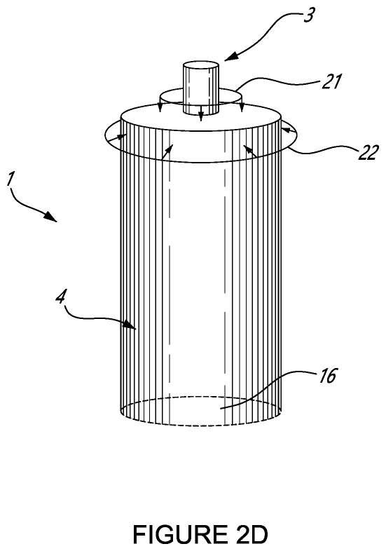

The present disclosure provides a scalable bottom-up approach utilizing a thermal plasma method, and boron-containing precursors that are injected into the thermal plasma in solid form and go through melting and/or evaporation. The term “thermal plasma” as used herein, refers to a plasma state where collisional equilibrium is attained between the free electrons and the heavy species (ions, atoms, and molecules). In a thermal plasma, a single temperature value or a proximal (±) range of temperature values may be used to describe the local plasma state. Making reference to FIG. 2A, a system 1 is provided for the production of SC-BNNS or SC-BCNNS. A thermal plasma 2 is initiated at a plasma zone 3 located upstream of a reaction chamber 4. In one embodiment, the thermal plasma 2 is an inductively coupled plasma, for example a radio frequency inductively coupled plasma. In other embodiments, thermal plasma may be direct current (DC) torch plasma, microwave plasma or a combination of them. In any embodiment, thermal plasma must provide the specific temperature-velocity requirements for generating SC-BNNS or SC-BCNNS. The system 1 includes a power source 5 to ignite and stabilize the thermal plasma 2. For example, the power source 5 can be a radio frequency generator or a generator of alternative current or direct current. Therefore, the system 1 can include an energy coupling/dissipating source 6 for the plasma torch such as a water-cooled copper coil, having for example four turns, wrapping a plasma confining tube with the system being powered with an alternative current coupled to the thermal plasma 2. In an exemplary embodiment, an inductively coupled plasma is obtained with a TEKNA PL-35 plasma source. The temperature of the hot zone in the thermal plasma 2 can reach at least about 3,000 K, at least about 5,000 K, at least about 8,000 K, at least about 9,000 K, at least about 10,000 K, at least about 11,000 K or at least about 12,000 K. The temperature can be between about 3,000 K to about 25,000 K, between about 5,000 K to about 20,000 K, between about 8,000 to about 12,000 K or about 10,000 K. The thermal plasma 2 is a heat source that can be readily adapted to an increase in production level by varying the power intensity and power type of the thermal plasma 2. Thus, the thermal plasma 2 can be scaled-up along with the reaction chamber 4 for an implementation into an industrial setting.

The thermal plasma 2 requires a flow of a plasma-source gas. The system 1 thus comprises a plasma-source gas compartment 7 comprising typically a gas that is in fluid communication with the plasma zone 3 via lines 8. The lines 8 thus comprise a flow of plasma-source gas. In one embodiment, the plasma-source gas may be provided centrally at the plasma zone 3 with or without a vortex generating mechanism. Examples of the plasma-source gas include but not limited to Ar, He, Ne, Xe, N₂, H₂, NH₃ and combinations thereof. The plasma-source gas can be fed to the reaction chamber at a flow rate of between about 10 to about 60 standard liter per minute (slpm), between about 10 to between about 14 slpm or between about 10 to about 20 slpm. The flow rate of the plasma-source gas will vary depending on the scale of the thermal plasma 2 requirements. The values provided are appropriate for a laboratory scale SC-BNNS production. In an industrial setting the flow rate of the plasma-source gas can be from less than 1 slpm (for example for a microwave plasma) to about 500 slpm (for example a DC plasma). In one example, the flow rate is around 300 slpm for an industrial setting high power ICP system such as 100 kW or more.

To produce SC-BNNS or SC-BCNNS, the present method may require a nitrogen rich environment in the reaction chamber 4. To provide nitrogen, the system includes a nitrogen compartment 9 containing nitrogen-source gas for example nitrogen gas (N₂) and/or ammonia (NH₃). The nitrogen compartment 9 is in fluid communication with the plasma zone 3 via lines 10. The lines 10 comprises a sheath gas flow that comprises nitrogen, examples include a mixture of nitrogen and another inert gas such as Ar. In one embodiment, the sheath gas flow further comprises the inert gas. The flow rate of nitrogen in the sheath gas side may be between about 5 to about 25 slpm, between about 8 to about 15 slpm, or about 10 slpm. If the sheath gas flow comprises the inert gas, the flow rate of the inert gas may be between about 35 to about 120 slpm, between about 35 to about 100 slpm, between about 40 to about 80 slpm, between about 38 to about 42 slpm, or about 40 slpm. It is essential to maintain an excess of nitrogen in the reaction chamber in order to obtain a product of adequate quality, therefore as the method is scaled up the nitrogen flow rate can be increased to ensure an excess of nitrogen. In one embodiment, the nitrogen compartment comprises N₂ gas. In a further embodiment, the sheath gas flow can be supplied peripherally at the plasma zone 3. In industrial scale the flow rate and power has to scale accordingly. Indeed the residence time depends on the plasma power. Generally, a high power will induce a shorter residence time and a low power induces a higher residence time. In one embodiment, the flow rate of the sheath gas flow can be between less than 1 slpm (for example microwave plasma) to about 500 slpm (DC plasma). In industrial ICP system can operate a flow rate of up to 300 slpm.

The present method employs a source of boron, for example a powder. The system 1 therefore comprises a boron compartment 11 that includes a source of boron-containing material that in some embodiments can be in a solid, liquid or gas form or any combination thereof. The boron-containing material may be selected from the group consisting of, for example, ammonia borane, amorphous boron particles, crystalline boron particles, boron carbide, boron trioxide, boric acid, boron trichloride and diborane or combinations of any of boron-containing materials. The boron compartment 11 is in communication with the plasma zone 3 through line 12 that leads into probe 13. The probe 13, which may be a cooled probe for example a water-cooled probe, reaches directly into the thermal plasma 2 to deliver the boron source. The feeding rate of boron to the reaction chamber 4 can optionally be controlled by a control system coupled to the boron compartment 11 or the line 12. The feeding rate of boron at the laboratory scale can be, for example, between about 1 to about 10 mg/min or between about 1 to about 5 mg/min. For a scale up to an industrial level process, the boron feed can be increased to higher suitable flow rates. The boron-containing material can be flowing to the plasma zone 3 by for example the effect of gravity, for example can be carried to the plasma zone 3 using a carrier gas or a carrier liquid. A carrier gas for example is nitrogen gas, and a carrier liquid for example a nitrogen-containing solvent.

To produce SC-BCNNS, a carbon source has to be provided. The carbon source can be a solid carbon source, a liquid carbon source or a gaseous carbon source. The system 1 thus further comprises a carbon compartment 11a that includes a source of carbon containing material. In some embodiments, the carbon source is methane, ethane, propane, melamine and dicyandiamide, carboxyphenylboronic acid, boron carbide, amines, carboxyphenylboronic acid, and trimethylamine borane. The carbon compartment 11a is in communication with the plasma zone 3 through the line 12a. The feeding rate of carbon to the reaction chamber 4 can optionally be controlled by a control system coupled to the boron compartment 11a or the line 12a. The BCNNS structure is generated upon providing atomic carbon in the plasma stream within the window of homogeneous nucleation of the nanosheet structure. Conditions can be set in order to make available atomic carbon within the nucleation and growth window of SC-BNNS, which is a complex determination in view of the specific temperatures involved for the vaporization and dissociation of the various B, C, and N precursors

In a preferred embodiment, the temperature is in the order of 10,000 K in the plasma volume (hot zone) at the plasma zone 3. Once injected to the hot zone of the plasma, the boron-containing precursors melt and/or vaporize in the nitrogen-rich environment to make boron nitride forming species, the building blocks of SC-BNNS and SC-BCNNS. Indeed, the thermal plasma 2 breaks down, to some extent, the nitrogen and boron into their respective various atomic species. In embodiments where SC-BCNNS are produced, the carbon source is provided and dissociates, to some extent, in the hot zone to provide elementary carbon. The created boron, nitrogen and optionally carbon mixtures are then transported into the reaction chamber 4 where controlled quenching takes place causing the melts/vapors to undergo supersaturation/supercooling, resulting in homogeneous, respectively heterogeneous nucleation pathways of new nanostructures. Under very specific nucleation conditions, fine solid products having specific structures can form by this process. This is achieved through a strong control of the thermal history of particle nucleation and growth that limits recirculation fields in the reaction chamber 4. This thermal history should provide uniform residence times for reactants in the hot zone of the thermal plasma 2, condensation zone 14 and the growth zones 15. The semi-continuous nature of this process allows easy scale-up to produce large quantities owing to the nature of the thermal plasma 2 processes which creates atmospheres of high temperature, high energy density and large densities of reactive species. The thermal plasma 2 produces a temperature gradient in the reaction chamber 4 which dictates where the condensation zone 14 and the growth zone 15 will form. The temperature is the highest at the plasma zone 3 where the thermal plasma 2 is and decreases gradually to the condensation zone 14, the growth zone 15, then the outlet 16 of the reaction chamber 4.

It is important to have the gases coming into the reaction chamber 4 from the plasma zone 3 take on a laminar flow in the reaction chamber 4. A laminar flow can be defined as a flow where recirculation and turbulence are substantially eliminated in the reaction chamber 4. Alternatively, the laminar flow can be defined as a flow where recirculation and turbulence are eliminated in the reaction chamber 4.

A characteristic of thermal plasmas is their high viscosity because of electrical cohesion of the species. Their viscosity may be estimated to about two thirds of that of water. Thermal plasmas generally exhibit in the radial direction a transition between a viscous plasma and a turbulent gas where each have vastly differing physics in terms of the atomic or molecular interactions. The turbulent zones of thermal plasmas are avoided in the present methods using a laminar flow. The flow direction can be controlled using the geometry of the reaction for example a conical reaction chamber (FIG. 2A) or by using other means such as sheath gas injections peripherally and axially (FIG. 2D). Furthermore, the laminar flow directly affects the two-dimensional nucleation and growth processes in the reaction chamber 4 as well as the species density. Indeed, turbulence can be detrimental to the two-dimensional nucleation and growth processes needed to obtain SC-BNNS or SC-BCNNS.

A further important characteristic that promotes the two-dimensional nucleation and the formation of SC-BNNS or SC-BCNNS is the controlled residence time in a nucleation temperature field. In one embodiment the temperature is between about 2000 to about 5000 K, about 2000 to about 5500 K, about 2000 to about 4000 K, about 2200 to about 3500K, about 3000 to about 5000 K, or about 3000 to about 4000 K.

The geometry of the reaction chamber 4 can be used to control and create the laminar flow. In the case of FIG. 2A, the laminar flow is a laminar expansion flow and allows control at the history of the nucleation process, while flow recirculation and turbulence do not allow to control this nucleation history. Poor or no control over the history of nucleation generates impurities, and causes difficulty in generating the proper two dimensional structures. In one embodiment, the expansion is an axisymmetric expansion. The expansion may be defined as moving away or expanding from an axis of the reactor extending from the plasma zone 3 to the outlet 16. For example, the axis can be the central axis of the reaction chamber 4. The expansion occurring in the reactor can be caused by the geometry of the reactor such as a conical reactor exemplified in FIG. 2A. Furthermore, in one embodiment the plasma torch exit nozzle is smaller in diameter than the chamber diameter. Therefore, the high temperature jet in the reactor will expand in the radial direction. This can be explained simply by a transfer of very high axial kinetic energy into a more isotropic kinetic energy of the gas molecules. In the reactor of FIG. 2D, peripheral injections of cool gas helps preventing such radial expansion (i.e. pushing the flow downstream of the nucleation zone) which would otherwise typically result in strong turbulence at the radial periphery of the jet. The present disclosure contemplates combining one or more of the described features, for example a cylindrical reactor with the same internal diameter as the plasma torch exit nozzle can be used. This would result in a long reactor to eliminate the recirculation paths and control the temperature and residence times.

Without wishing to be bound by theory, a controlled nucleation temperature field (NTF) provides the means for setting first the nucleation of a stable critical cluster that is highly crystalline for the production of SC-BNNS or SC-BCNNS. Such high crystallinity is achieved because of the extreme temperatures in the thermal plasma providing the means for removing crystalline defects and minimizing internal energy. The initial critical cluster is in the shape of a single crystal. Once formed, the controlled size extension of the NTF enables diffusion of the B and N precursor species to the surface of the single crystal. This initial BN crystal has a stacked layer organization with superposed BN sheets as shown in FIG. 1. The top and bottom sheets of the stacked BN single crystal are very stable chemically and have a low probability of integrating new B and N atoms (as well as C atoms when SC-BNNS is produced), together with a high surface diffusivity of the B, N and optionally C atoms arriving on the surface of these top and bottom sheets. Carbon has a slight, minor or negligible effect on the BN nucleation since pure C structures (i.e graphene sheets) have a similar honeycomb the BN structure. This slight interference may result in atomic structures with some waviness, unlike SC-BNNS and graphene. Stacking C integrates as a replacement for B or N in the hexagonal BN structure upon nucleation. The initial stable critical cluster is crystalline (i.e. the layered structure of hexagonal sheets) which may be in the order of 2 nm edge sizes. Diffusion of B, C, N to this cluster induces its growth. It is believed that atoms diffuse easily on the top/bottom surfaces towards the edges, increasing the 2D dimensions of the sheets. On the contrary, the edges of the initial BN single crystal cluster have dangling bonds with a high probability of attachment of new B and N atoms. This drives a process of two-dimensional sheet-like extension of the initial single crystalline cluster, the thickness itself staying somewhat similar to the initial stable critical cluster thickness. The extension of the controlled NTF and the local density of the B and N precursor species both control the duration of this two-dimensional growth process, and hence the lateral size of the SC-BNNS or the SC-BCNNS generated. Also, the extreme temperatures occurring in this NTF generated by a thermal plasma ensure maintaining the very strong crystallinity throughout the stacked two-dimensional sheets, this being made through energy minimization that tends to eliminate crystalline defects in the structure.

FIG. 2B provides computational fluid dynamic (CFD) modeling of the flow lines under standard conditions in the reactor shown in FIG. 2A, indicating that no flow recirculation is present throughout the reactor. FIGS. 2B and 2C also indicate a control of the cooling rates and length scales of specific flow lines of the precursor species is achieved in the specific temperature zones of the reactor. Both parameters also indicate a control of the residence times for nucleation and growth and of the thermal history of the flow in the nucleation zone. FIG. 2B shows that no flow recirculation zones are present in the reactor. A cross section of half of the full reactor is given (Lower Figure) including the Inductively Coupled Plasma Torch (Extreme Left side) and the purely radial flow of the pumping zone (Extreme Right side) that includes the square annular volume of the pumping manifold. The Upper Figure shows an enlargement of the high temperature section of the reactor with the calculated positions of the 5000 K and 3000 K temperature isotherms. The temperatures zones can be well controlled because there is no recirculation in the reactor as shown in FIG. 2B. Table 1 below summarizes the flow line number as given in FIG. 2C, the cooling rates of the flow between the 5000 K and 3000 K isotherms on each flow line in K/s, and the actual length, in meters, of each flow line between the two isotherms. Both the cooling rates and the length of the flow lines between the two isotherms show strong uniformity and a good control of the quench conditions imposed to the SC-BNNS or SC-BCNNS precursor species. As a semi-continuous process (not batch), the present method is highly cost effective for the industrial setting and large scale productions. Indeed, the process is readily scalable to higher power and production levels as the flow/energy fields and the geometry of the reaction chamber 4 for generating the SC-BNNS or SC-BCNNS can be modeled and thus scaled up easily. The reaction chamber 4 has the plasma zone 3 opposite of the outlet 16. In one embodiment, the plasma zone 3 and the outlet 16 are opposite on the same vertical plane. In other embodiments, the plasma zone 3 and the outlet 16 may be opposite and 1°, 2°, 3°, 4°5°, 6°, 7°8°, 9°10°, 11°, 12°, 13°, 14°, or 15°off said vertical plane. In one embodiment, the plasma zone 3 and outlet 16 are opposite in a horizontal axis. In one embodiment, the cross sectional area of the reaction chamber 4 increases from the plasma zone 3 to the outlet 16. The increase in cross sectional area is made to substantially prevent any recirculation. In one embodiment, the reaction chamber 4 has a constant or substantially constant cross sectional area with an additional sheath gas injected axially 21 and possibly peripherally 22 at the top of reaction chamber 4 to prevent recirculation loops of the hot gas and induce the laminar flow as shown in FIG. 2D.

TABLE 1
Summary of flow line numbers

| Flow | Cooling rates between | Distance Δz |
|---|---|---|
| line | 5000 K and 3000 K isotherms | between isotherms |
| number | (10⁵ K/s) | (m) |
| 1 (axis) | 1.54 | 0.085 |
| 2 | 1.54 | 0.085 |
| 3 | 1.56 | 0.084 |
| 4 | 1.49 | 0.087 |
| 5 | 1.38 | 0.094 |
| 6 | 1.21 | 0.108 |
| 7 | 6.58 | 0.128 |
| 8 | 1.72 | 0.061 |

The geometry of the reaction chamber 4 as depicted in FIG. 2A is also adapted to allow an appropriate residence time for SC-BNNS or SC-BCNNS forming species and can be readily scaled up. In the condensation zone 14, the boron nitride condensates to form stable nuclei which subsequently nucleate and grow in the growth zone to form SC-BNNS or SC-BCNNS. The residence time can be modified by varying the operating pressure. Modifying the residence time allows, in turn, to cause variations in the lateral size and the thickness of the SC-BNNS and SC-BCNNS produced and reduce contaminations. The residence time in the nucleation and growth zone provides control over the lateral size of the 2D structures formed (atomic layers). On the other hand the thickness of the structure (number of atomic layers) is generally controlled by the cluster size which is dependent on the temperature and density. In one embodiment, the reaction chamber 4 has a conical shape as exemplified in FIG. 2A or a cylindrical shape as exemplified in FIG. 20. The reaction chamber 4 can optionally comprise a wall cooling system to cool its walls 17, for example the walls 17 may be water-cooled walls. In a further embodiment, the reaction chamber 4 can optionally comprise a wall heating system to heat its walls 17. In yet a further embodiment, the internal wall can contain a thick layer of an insulating material for example a ceramic, graphite or boron nitride. The reaction chamber 4 can also optionally comprise one or multiple view ports 18 in order to monitor the conditions of the thermal plasma 2 and to perform plasma diagnostics.

The pressure inside the reaction chamber is an essential parameter in order to obtain highly crystalline and highly pure product. The pressure in the chamber is varied to be between about 20 kPa to about 200 kPa, between 20 kPa to about 100 kPa, between about 40 kPa to about 75 kPa, between about 50 kPa to about 70 kPa, between about 60 kPa to about 64 kPa or about 62 k Pa. Furthermore, pressure plays a significant role in the size and the thickness of SC-BNNS and SC-BCNNS.

The formed SC-BNNS or SC-BCNNS then exit the reaction chamber through the outlet 16. In some embodiments, the SC-BNNS and the SC-BCNNS are produced in powder form. Powder is a desirable form for easier dispersion in paints and nanocomposites as well as for avoiding contamination. Indeed, in some embodiments, the method of the present disclosure has limited or avoids entirely oxygen contamination. The system 1 may optionally comprise a collecting plate 19 downstream of the outlet 16 to collect the SC-BNNS or SC-BCNNS produced. The collecting plate may form a closed environment with the reaction chamber as shown in FIG. 2A in which case the collecting plate 19 comprises an exhaust 20 connected to a vacuum pump system. In a further embodiment, the collecting plate 19 may be replaced by a flowthrough port with a filtration system connected to outlet 16 (not illustrated) to collect SC-BNNS or SC-BCNNS.

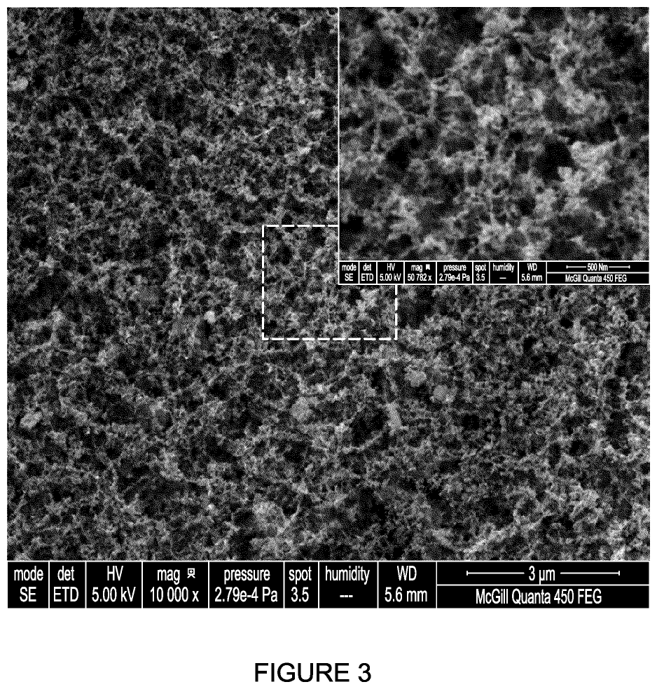

The SC-BNNS obtained by the present method exhibit a highly crystalline structure and are of high purity. No BNNT are observed to be generated by the present method, meaning that no separation processes are needed to separate other BN-based nanomaterials from the SC-BNNS generated. The crystallinity of the SC-BNNSs is at least 95%, 96%, 97%, 98% or 99% and the purity is at least 95%, 96%, 97%, 98% or 99%. The SC-BNNS also have an excellent chemical composition characterized by an atomic ratio of B to N being approximately 1:1. For example, the atomic ratio B:N of the SC-BNNS according to the present disclosure is between about 0.95:1.05 to about 1.05:0.95, between about 0.97:1.03 to 1.03:0.97, between about 0.98:1.02 to about 1.02:0.92 or about 1:1. The SC-BNNS of the present disclosure can also be characterized as thin because each sheet of it contains between 1 atomic layer to 50 atomic layers. Indeed, in one embodiment the SC-BNNS have a thickness of 1 to 40 atomic layers or 2 to 30 atomic layers. In a further embodiment, the SC-BNNS have a thickness of between about 3 to about 8 nm. An individual SC-BNNS nanosheet obtained by the present method is characterized as having a small surface area. Indeed, in one embodiment the surface area of a single sheet is between about 10 to about 1500 nm², between about 10 to about 1000 nm², between about 20 and 200 nm² or between about 10 to about 100 nm². Therefore, the single crystal boron nitride nanosheets (SC-BNNS) of the present disclosure correspond to single crystal two dimensional structures of stacked atomic layers. The SC-BNNS of the present disclosure can also be characterized by a symmetry of planar atomic stacking from a group of boron nitride atomic planes (FIG. 1) held together by Van der Waals forces. The product collected from the synthesis reactor is in the form of a fine powder as seen at low resolution SEM (FIG. 3). Main characteristics of the collected product are its homogeneity and a large quantity of powders produced in a single-step continuous operation in comparison to other SC-BNNS synthesis technologies.

In the synthesis of SC-BCNNS other nanostructures/nanomaterials may be produced as by-product. For example, ‘pure’ graphene, SC-BNNS, carbon black, carbon black coated with SC-BNNS or SC-BCNNS, amorphous boron coated with SC-BNNS may be formed. Improved control over the temperature inside the reactor can help reduce the formation of such by-products. Additionally, optimizing the various velocities (hence cooling rates) can also modify the clusters nucleation and growth conditions of the 2D/3D materials (2D being the nanosheets and 3D being the coated and uncoated carbon and boron spherical particles thereby reducing by-product formation.

### Example 1 SC-BNNS Production Using Ammonia Borane as Precursor

An inductively coupled plasma system using a TEKNA PL-35 plasma torch and a conical reaction chamber was used to melt/vaporize/decompose the boron-containing precursor which was ammonia borane. The half-angle of the cone of expansion was about 7 degrees. The power generator that was used supplies an alternative current (AC) at 4 MHz. The inductively coupled plasma (ICP) torch was equipped with three inlets. The first inlet is used to provide the plasma-source gas which was Ar fed at 15 slpm at room temperature. The second inlet was used for the sheath gas injection which was a combination of Ar fed at 40 slpm and N₂ at 10 slpm. The reactor operating pressure was 62 kPa. The ICP torch plate power was maintained at about 29 kW to ensure plasma stability, resulting in a power coupled to the plasma of around 14.5 kW. A fine solid powder of ammonia borane (NH₃BH₃, assay 97%) was fed at a rate of 1-2 mg/min to the ICP torch through a water-cooled probe. Once in the hot zone, the solid powders melted and vaporized in the nitrogen-rich environment to make BN-forming species, the building blocks of SC-BNNS. The formed SC-BNNS (and by-products) then accumulated on the water-cooled collecting plate.

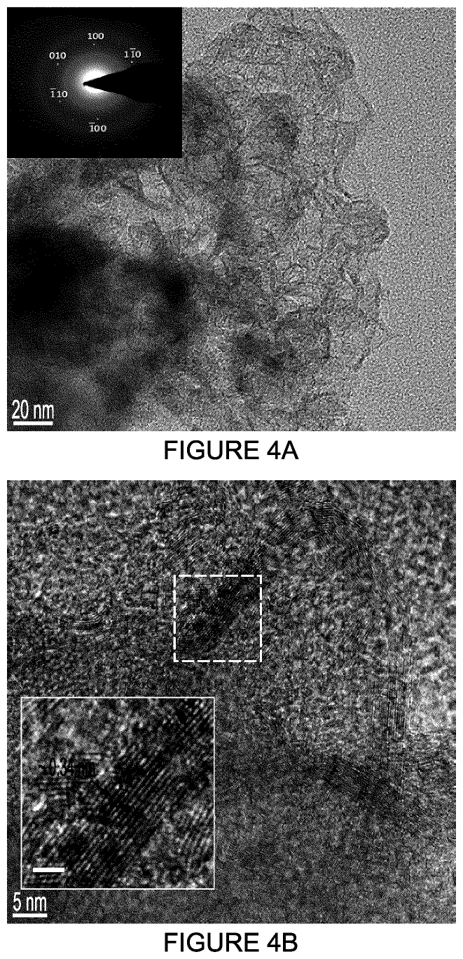

FIG. 3 shows a scanning electron microscopy (SEM) image for the fine powders of SC-BNNS produced in the method presented in this disclosure using ammonia borane as the boron source. This image shows a porous-like deposit which is a homogenous and uniform powder of SC-BNNS at low resolution. Without wishing to be bound by scientific theory, the synthesis of SC-BNNS using thermal plasma in a single semi-continuous step results in largest throughputs compared to other synthesis technologies. Low and high resolution transmission electron microscopy (TEM) images of the powders are shown in FIGS. 4A and 4B. FIG. 4A shows coalesced and transparent-looking nanosheets with in-plane dimensions of roughly 20-30 nm. FIG. 4B clearly shows cross-sections of 2-dimentional crystalline plane stacking geometry that are very similar to graphene. The average thickness of the sheet stackings, based on the figure, is estimated at around 3 nm, which yields a typical number of 8 atomic layers per sheet. The interlayer spacing in each stacking is measured to be 0.34 nm, which corresponds to the theoretical distance between two planes in graphitic-BN. The inset of FIG. 4A illustrates the pattern of Selected Area Electron Diffraction (SAED) associated with the TEM image in FIG. 4A. The pattern shows the sharp and distinctive sixfold symmetry related to hexagonal boron nitride (h-BN) which indicates the high crystallinity of the nanosheets.

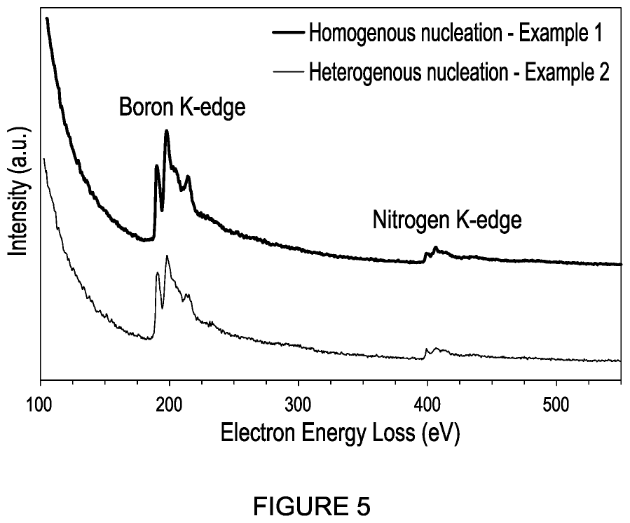

Energy-Dispersive X-ray Spectroscopy (EDX) was used to investigate the chemical composition of the formed SC-BNNS and the contamination present within the formed powders. The results deduced from the EDX spectrum are shown in Table 2. The B:N atomic ratio was ˜1:1 as seen in table 2, confirming that stoichiometric boron nitride nanosheets were effectively generated. The SC-BNNS were dispersed on an aluminum-alloy scanning electron microscope (SEM) stub then coated with a 2 nm-layer of gold to enhance the SEM imaging and remove the surface charging effect of the electron beam on the insulative SC-BNNS. This explains the presence of the other elements (e.g. oxygen, carbon, copper, and gold). The signals of the heavy elements i.e. Al, Cu and Au were removed from the calculations to minimize the error associated with B and N atomic ratios. The chemical composition of SC-BNNS was also confirmed using Electron Energy Loss Spectroscopy (EELS). FIG. 5 (top) represent the EELS spectrum for a representative sample of SC-BNNS. As can be seen, there are only peaks that correspond to boron and nitrogen (i.e. no presence of carbon or oxygen is observed).

TABLE 2
Summary of EDX results

| Element | Weight % | Atomic % | Net Intensity. | Error % |
|---|---|---|---|---|
| B | 30.62 | 36.11 | 38.22 | 9.14 |
| C | 15.64 | 16.60 | 34.61 | 12.78 |
| N | 39.37 | 35.84 | 127.11 | 10.14 |
| O | 14.37 | 11.45 | 53.33 | 11.66 |

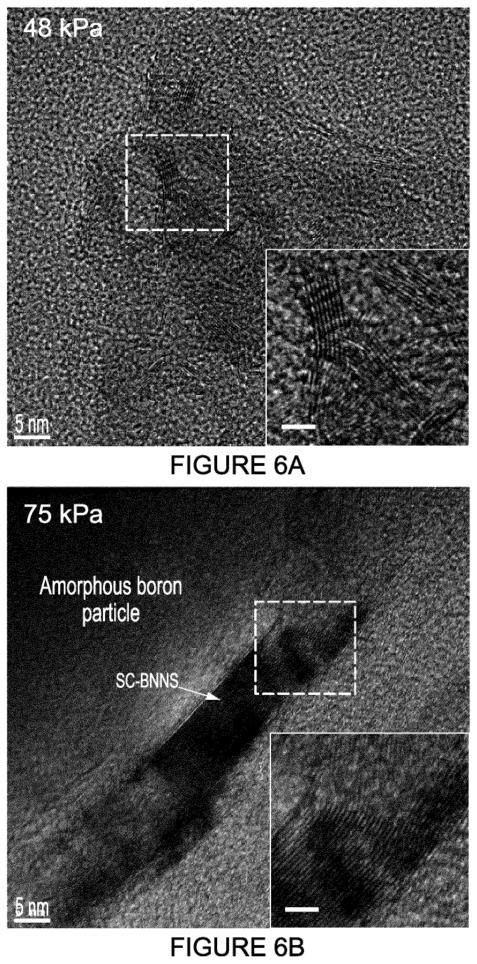

Generally, the formation of nanoparticles in thermal plasmas can be affected by many interrelated variables. For example, the power coupling efficiency between the induction coil and the plasma strongly influences the temperature of the plasma core, while the pressure affects the axial velocity fields as well as the temperature profiles along the reactor. When these variables change, the thermal evolution of the various species and the quenching rates of the vaporized precursors are also modified. This results in various morphologies and sizes of the nanoparticles when condensed. In Example 1, the power was maintained constant at 29 kW while the relation between operating pressure and nitrogen loading and its impact on the process outcomes are observed. The pressure was either decreased or increased relative to 62 kPa while marinating the flow rate of N₂ at 10 slpm in the sheath gas. Deviating from 62 kPa was found to have a major impact on the SC-BNNS sheet dimensions and the overall purity of the product. At 48 kPa, SC-BNNS tend to show smaller in-plane sizes and sheet thicknesses as seen in FIG. 6A. The observed spatial dimensions range from 5 to 10 nm and the thickness go down to as few as 1-7 atomic layers which are smaller than the dimensions of SC-BNNS grown at 62 kPa. Operating the reactor at 48 kPa comes with the cost of forming contaminations that are possibly unreacted/unvaporized BNH-based polymeric materials that results from incomplete heating of ammonia borane. The presence of the unvaporized materials limits the formation of vaporous precursors that lead to SC-BNNS growth. FIG. 6B shows the effect of operating at 75 kPa, i.e. a pressure higher than the base case of 62 kPa. It is clear that the SC-BNNS sheets are much larger and thicker than in both other cases. The spatial dimensions in this case were in the range of 40-70 nm while the thickness was about 10 nm, amounting to around 35 atomic layers per sheet. Although BNH-based polymeric contaminating materials are not present in this case, large boron particles were widely formed, which is a disadvantage when it comes to the overall purity. These materials characteristics observed in FIGS. 6A and 6B are primarily the result of variations of the residence time of the precursors in the SC-BNNS nucleation and growth regions of the reactor.

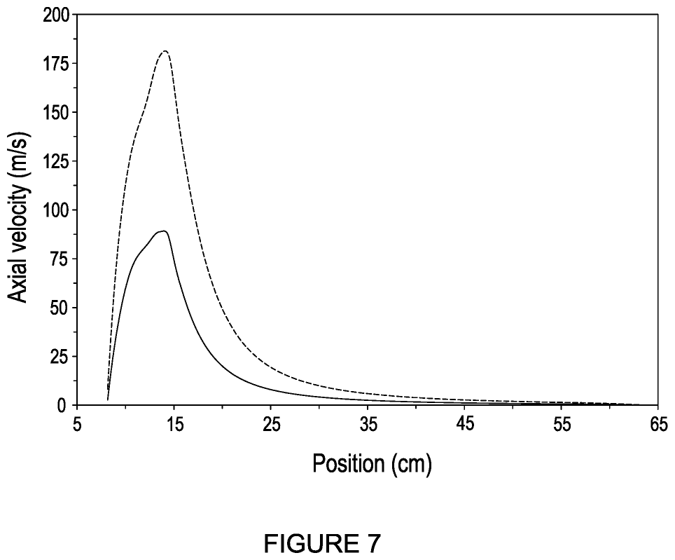

Computational fluid dynamics (CFD) modeling was used to show a typical trend of the effect of the operating pressure on the formation of SC-BNNS in the reactor in argon plasma conditions and a sheath gas containing 10 slpm N₂ (FIG. 7). It was found that, at a low pressure (i.e. 27 kPa), precursors experience roughly 2.3 times higher axial velocities compared to the case of a higher pressure (i.e. 62 kPa). Employing this modeling results in the present context, the injected ammonia borane experienced higher axial velocities due to lower operating pressures and consequently shorter residence times in both the hot zone for vaporization and in the SC-BNNS nucleation/growth zone. At a pressure of 48 kPa, the vaporization process is not highly efficient and yields considerable amounts of polymeric BNH-based by-products. The vaporized part of ammonia borane further produces B-N to form SC-BNNS embedded in the unvaporized part (FIG. 6A). On the contrary, when the operating pressure is increased to 75 kPa, the residence time is expected to be longer, and that translates into an excessive vaporization and decomposition of the precursor. As the vapors travel downstream in the reactor, boron vapor first undergoes supercooling and starts to nucleate into large particles. Subsequently, SC-BNNS grow horizontally as a separate phase on the surface of the boron particles (FIG. 6B). Further inspection of the TEM image reveals that the boron particle provide a surface for SC-BNNS growth and perhaps catalyzes the growth process as the dimensions of SC-BNNS are much larger compared to the case when boron particles are absent (FIG. 6A). Given the specific experimental conditions, 62 kPa seemed to be an optimal operating pressure for the reaction chamber geometry of the Examples (which was a conical shape) and for the type of thermal plasma used in which vaporization of the precursor and formation of SC-BNNS are accomplished with minimum creation of byproducts.

The effect of N₂ flow rate on SC-BNNS growth was evaluated while maintaining the operating pressure at 62 kPa. The flow rate of N₂ gas also plays a significant role. At a low flow rate of 0-5 slpm N₂, results (SEM/TEM images not shown) reveal boron particles being more predominant compared to SC-BNNS. This is expected since lowering N₂ gas would reduce the amount of N species needed for BN formation, which is a precursor for SC-BNNS formation.

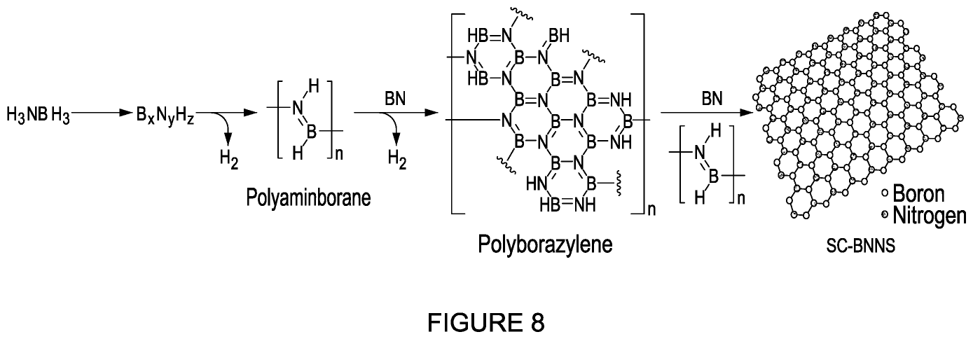

Without wishing to be bound by scientific theory, a possible model for the homogeneous growth of SC-BNNS is described herein. When ammonia borane is injected in the hot argon plasma zone, it melts and vaporizes to form mixtures of BₓN_{y}H_{z} and, B, N, H, and BN species. These vapors are then transported axially into the reaction chamber 4 in a steady state manner and undergo supercooling by a well-controlled rapid quenching. This step induces BₓN_{y}H_{z} species and N radicals to form BN species (and polyaminoborane networks) to nucleate into polyborazylene particles of critical spatial 2-D structures through a homogeneous nucleation scheme. Once stable, these nuclei serve as matrices for further condensation of the incoming flux of BN species. These species are transported by convective forces that are temperature dependent. On the surface of stable nuclei, BN/BₓN_{y}H_{z} species condensate to laterally propagate SC-BNNS while releasing hydrogen gas. This possible mechanism is depicted in FIG. 8. The SC-BNNS growth ceases when (i) the whole structure reaches a zone where diffusion to the growing particle reaches a lower limit because of the expansion geometry of the reactor, or (ii) when the temperature is below the BN solidification point. The SC-BNNS synthesis process of this example is therefore thought to be homogenous as it does not involve the formation of foreign nuclei such as boron particles or metallic catalysts.

### Example 2 SC-BNNS Production Using Amorphous Boron as Precursor

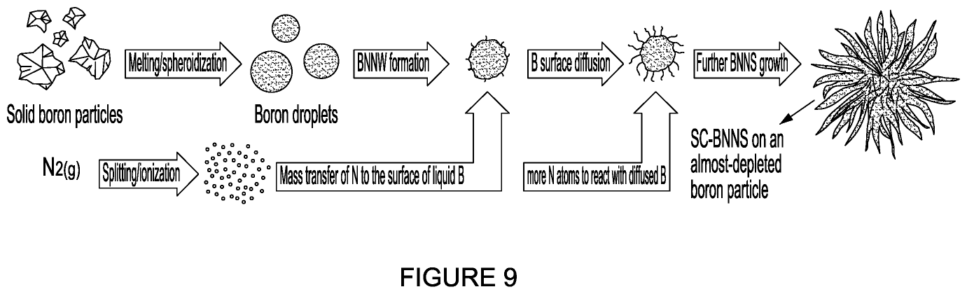

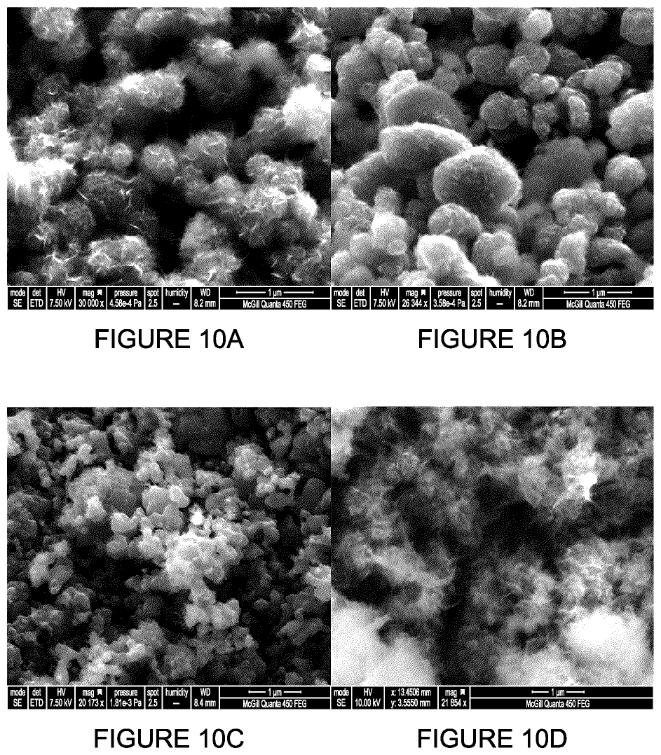

Another SC-BNNS synthesis route in argon plasma using a different precursor was explored, namely amorphous boron particles instead of ammonia borane as used in Example 1. The boron particles sizes ranged from 100 nm to 1.5 μm in diameter and the powder was fed at a rate of 5 mg/min. The plasma-source and sheath gases were maintained the same as in Example 1, the plasma-source being argon fed at 15 slpm and the sheath gas being a mixture of argon and nitrogen fed at 40 and 10 slpm, respectively. The operating pressure was maintained at 62 kPa. A possible growth mechanism is summarized in FIG. 9. Solid boron enters the hot plasma zone and melts forming liquid boron droplets. Small droplets can fuse into each other forming larger droplets. Simultaneously, nitrogen gas splits and ionizes to form active N species. These species are transported to the surface of the boron droplets to form a new solid phase of small boron nitride nanowalls (BNNWs) in a heterogeneous nucleation scheme. While being above the boron melting point (about 2350 K), atomic B diffuses on the surface to react with N to propagate BNNWs into SC-BNNS. This progresses until SC-BNNS growth ceases which happens when B and/or active N content depletes, or when the whole structure reaches a temperature below the boron melting point.

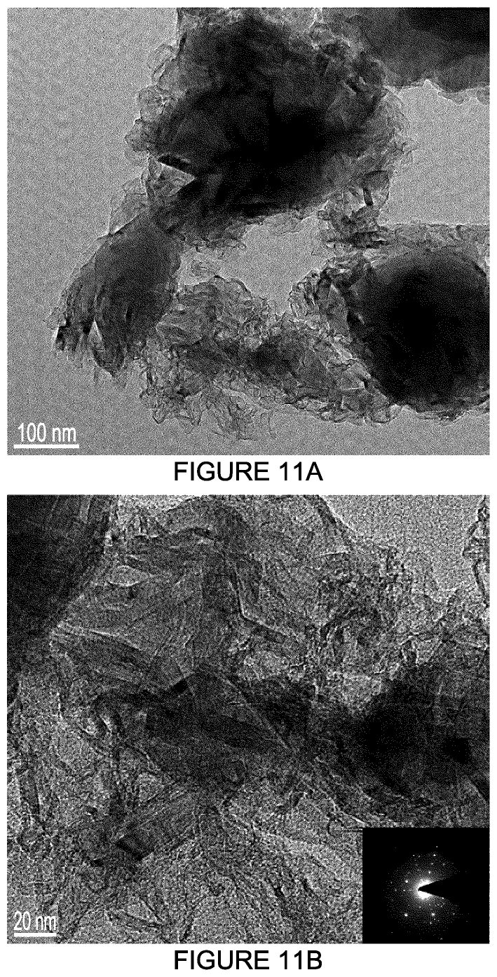

FIG. 10A shows a SEM micrograph of the resulting product. Wavy and thin SC-BNNS are seen to grow vertically as boron nitride nanowalls (BNNWs) atop boron particles resembling a corona-like geometry. The boron particles morphology appear to have been transformed into spherical structures through a plasma spheroidization process resulting in uniformly sized spheres. The TEM images for the same sample are shown in FIGS. 11A and 11B. BN sheets are surrounding the boron particles. The lateral spatial dimensions and the thickness of the flakes were in the range of 100×100 nm² and 8 nm, respectively. Interestingly, these dimensions are substantially larger than those formed in Example 1 using ammonia borane at the same operating conditions. From FIG. 10B, it can be seen that the BN sheets seem to originate from the surface of the boron particles suggesting a base-growth mechanism (FIG. 9). The SAED pattern in the inset shows the characteristic hexagonal crystalline planes of many BN layers in various orientations. This again reflects the high crystallinity of the SC-BNNS. These sheets consist mainly of boron and nitrogen elements as determined by the EELS spectrum in FIG. 5 (bottom).

To shed light on controlling phenomena that affect the growth of SC-BNNS, the operating pressure and nitrogen flow rate in the sheath gas were varied to deviate from the conditions that resulted in SC-BNNS of FIG. 10A. First, the operating pressure was varied while keeping the N₂ flow rate at 10 slpm. At a low pressure of 27.6 kPa, the BN sheets grew on boron particles in relatively small amounts and sizes as seen in FIG. 10B. However, increasing the pressure higher to 90 kPa seems to prevent effective SC-BNNS growth, the sheets being hardly noticeable as in FIG. 10C. Surprisingly, in spite of the very different nature of the precursor and of the envisioned nucleation and growth processes, the same optimum operating pressure of 62 kPa was observed for the generation of SC-BNNS when using boron powders in Example 2 with a heterogeneous nucleation scheme, as was observed using the ammonia borane in Example 1 with a homogeneous nucleation scheme. When increasing the nitrogen flow rate from 10 to 25 slpm keeping the optimum pressure and other parameters constant, the throughput of SC-BNNS in Example 2 is also seen to increase. This effect is seen in FIG. 10D, the size and quantity of the sheets were the largest within all the tested conditions, while the remaining boron content in this case was the smallest.

The possible heterogeneous growth mechanism of SC-BNNS as FIG. 10B suggests is a base growth process when the boron precursor is boron particles that have been heat treated by the plasma. This mechanism is depicted in FIG. 9. When boron particles are injected into the high temperature plasma zone, they mostly melt and partly vaporize. Boron has high melting and boiling points (2349 and 4200 K, respectively) and high heats of fusion and vaporization (50.2 and 489.7 kJ mol⁻¹, respectively). In addition, boron exhibits intrinsically relatively low thermal conductivity and thermal diffusivity (e.g. 2.15 W m⁻¹ K⁻¹ and 4.5×10⁻⁷ m² s⁻¹ respectively at 1000 K). Therefore, to completely vaporize the boron particles, their residence time in the hot plasma zone has to be sufficiently high and/or the precursor particle size has to be extremely small, among many other factors, for effective heat exchange to take place. The powder feedstock consists of agglomerates of coarse boron polyhedrons whose particle size ranges from 100 nm to 1.5 μm. Based on the above characteristics, it is likely that most of the boron particles are transformed by melting in the low-pressure plasma conditions rather than vaporizing. This melting transforms the boron particle morphology into spherical particles.

Without wishing to be bound by scientific theory, the following is thought to explain the SC-BNNS growth process. When boron particles are injected into the plasma zone at 62 kPa, they have enough residence time to mostly melt forming liquid droplets while being transported downstream to the reaction chamber. By the effect of surface tension of boron in the liquid state, particles undergo spheroidization to assume spherical shapes.

Some fraction of the nitrogen fed in the sheath gas dissociates in the hot plasma zones into atomic nitrogen and gets exited or ionized to form active N species. Then, the active N species bind with B on the surface of the liquid boron particle to form a solid phase of boron nitride nanowall (BNNW) that vertically grow in all directions in a base-growth process leading to a corona-like structure. Local concentration gradients of N on the surface of the particle create a driving force for convective mass transfer of N from the surroundings to the surface of the particle. Upon the presence of more active N on the surface, BNNW propagate further taking the shape SC-BNNS until the boron liquid particle is depleted, which represents an ideal case in which pure SC-BNNS are formed. SC-BNNS can cease to grow when the concentration of active N becomes insufficient due to recombination reactions that form N₂ gas (i.e. 2N→N₂). Moreover, SC-BNNS can cease to grow when the boron particle falls below its melting point.

In conditions where pressure is decreased from 62 kPa to 27 kPa while keeping the same N₂ flow rate (FIG. 10B), various boron particle sizes are formed as a result of an inefficient spheroidization process. The short residence time caused by the low operating pressure prevents efficient heat transfer to the boron particles and consequently only a thin layer of the particles may be melting. Further, a shorter residence time in the hot zone prevents efficient reaction between N species and the thin boron liquid layer which yields only small BNNW rather than propagated SC-BNNS. N species under this lower pressure condition recombine more rapidly once they depart the hot zone and only a limited amount of N reaches the surface of liquid boron before its temperature drops below the melting point.

In contrast, if pressure is increased from 62 kPa to 90 kPa at the same N₂ flow rate (FIG. 10C), the residence time for boron powder in the hot zone is long enough for effective vaporization rather than just melting. The plasma expansion then induces a rapid quench that condenses the boron vapor into liquid then into small solid boron particles, smaller in dimensions than the starting the material. Only a scarce amount of fibrous-like BN assemblies can be seen to form on the boron particles at this higher pressure. This is to be expected since the presence of a high concentration of N species is not synchronized with the presence of liquid boron droplets. The recombination reaction of N may be taking place before the condensation of boron vapors. The net result is only limited N species are existing in-phase with liquid boron before it solidifies.

Finally, increasing the nitrogen load in the sheath gas from 10 to 25 slpm while maintaining the optimum pressure of 62 kPa provides excess active N for the SC-BNNS formation (FIG. 10D). In these conditions, boron powder fed into the plasma zone experiences an adequate residence time for melting but not long enough to vaporize. The formed boron droplets enter a N-rich atmosphere in the reaction chamber leading to the evolution of a separate solid phase of BNNWs starting to grow and consuming both B_{liq} and N_{gas}. While active N species are still present in high concentrations, atomic boron diffuses to the surface of the particle promoting BNNWs propagation into SC-BNNS, in ideal cases, depleting the liquid boron content. In such a scenario, it is preferred to have small liquid boron droplets to be forming out of the melting process if one is targeting purity of the NC-BNNS. This requires using small and uniform boron particle sizes for the boron feedstock.

From the two Examples, it is apparent that SC-BNNS growth favors an operating pressure of 62 kPa in the homogenous (Example 1) and heterogenous (Example 2) processes for the specific reactor geometry used (conical) as well as the laboratory scale flow rates. This pressure provides a residence time necessary for ammonia borane to decompose into BₓN_{y}H_{z} and BN that allow SC-BNNS growth. For the boron particles precursor, 62 kPa is important for melting the boron powder in a plasma spheroidization process. In both cases, this pressure is essential to limit N species from recombining thus facilitating further growth in the SC-BNNS growth zone. Thus, it is vital to enrich that zone with N species by increasing the nitrogen flow rate.

Accordingly the present disclosure has demonstrated the homogeneous and the heterogenous synthesis of single crystalline flakes of boron nitride nanosheets in a powder form by a bottom-up approach using inductively coupled plasma (RF-ICP). The wording “bottom-up” is understood as the assembly of nanosheets from smaller basic units at the atomic/molecular level into the more complex nanosheets. The synthesis is strongly controlled through the laminar flow path-lines and optionally the geometry which allows for further control over uniform residence times in specific nucleation zones and prohibits re-circulations in the reactor.

The operating pressure in both examples is vital for controlling axial velocities of precursors vapors (in the homogenous nucleation, Example 1) and droplets (in the heterogenous nucleation, Example 2) and for limiting recombination reactions of N species which in both cases is an important aspect to minimize impurities/by-products. In line with that, it is found that N₂ loading played a significant role as to compensate for recombined N species. Furthermore, in the heterogenous growth of Example 2, liquid boron particle size is an important parameter because large particles tend to only be partially depleted in the SC-BNNS formation process while small ones tend to be fully depleted.

Remarkably, it was found possible to control the lateral sizes and the thickness of SC-BNNS by merely opting for either homogenous or heterogenous growth processes. This is an important advantage for applications involving controlled SC-BNNS sizes. It is also important to note that the present method is catalyst-free and time-effective which significantly contribute to the scalability of the method.

As seen therefore, the two examples described above and illustrated are intended to be exemplary only. Practitioners of thermal plasma systems can transfer the ICP-thermal plasma processes described herein by changing the plasma source to other thermal plasma generation devices such as a DC plasma torch or a microwave plasma torch. In Example 1, ammonia borane was used as a precursor which contains boron and nitrogen in its chemical composition. Thus, a person skilled in the art would appreciate that injecting nitrogen gas into the system is not always necessary to obtain the SC-BNNS. However, adding nitrogen gas to the reaction can result in an increase in the overall purity/quality of the product because of a reduced formation of boron and an increase in the formation of SC-BNNS. In Example 2, the precursor was boron particles which contains only boron in its chemical composition. For this reason, injecting nitrogen is essential to form SC-BNNS. Injecting a low amount of nitrogen results in little to no formation of SC-BNNS, while injecting more nitrogen enhanced the yield of SC-BNNS. In general, achieving an abundance of nitrogen be it in the environment or provided with the boron source improves the purity and quality of the SC-BNNs produced.

### Example 3 Production of SC-BCNNS Using Methane as the Carbon Precursor

SC-BCNNS were produced by introducing ammonia borane solid particles, nitrogen gas and methane gas in the argon plasma conditions to produce free-standing SC-BCNNS powders without the use of catalysts, solvents or substrates. The conditions are listed below in Table 3. The argon plasma provided high enthalpy heats to melt, vaporize and dissociate the solid precursor to obtain atomic boron and nitrogen. The injected methane dissociated to provide atomic carbon necessary for SC-BCNNS. Both ammonia borane and methane produced hydrogen gas that left the system as a gaseous by-product. Powders were collected downstream of the flow on the product collecting plate.

TABLE 3
Conditions of SC-BCNNS synthesis in RF-ICP system

| | |
|---|---|
| Central gas | Argon (15 slpm) |
| Sheath gas | Argon (40 slpm) + Nitrogen (0-10 slpm) |
| Carrier gas | Argon (0.5 slpm) |
| Secondary gas | Methane (0.1-1 slpm) |
| Solid particles | Ammonia borane (1.5 mg/min) |
| Power | 14.5 kW |
| Pressure | 62 kPa |

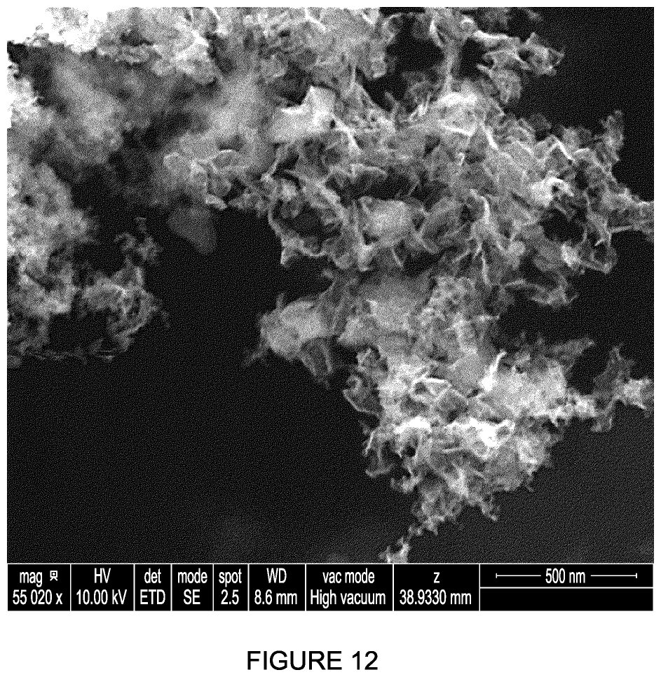

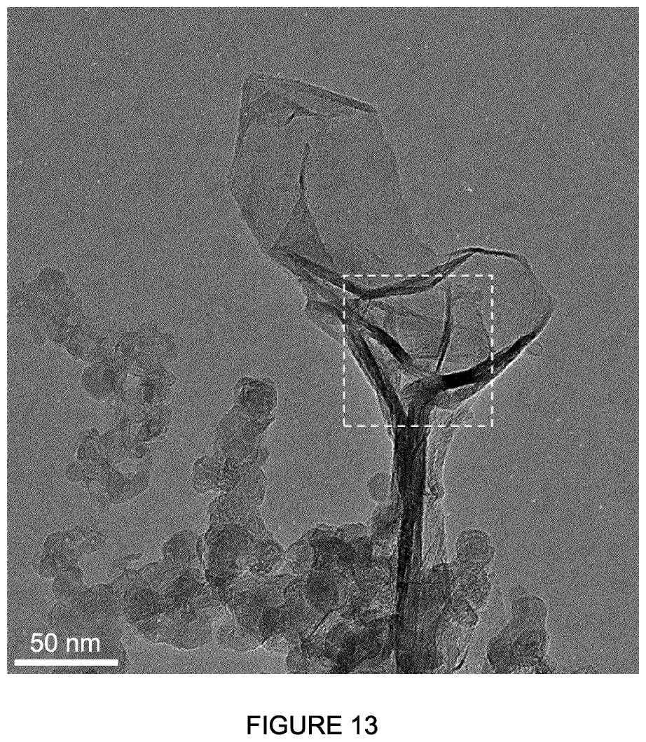

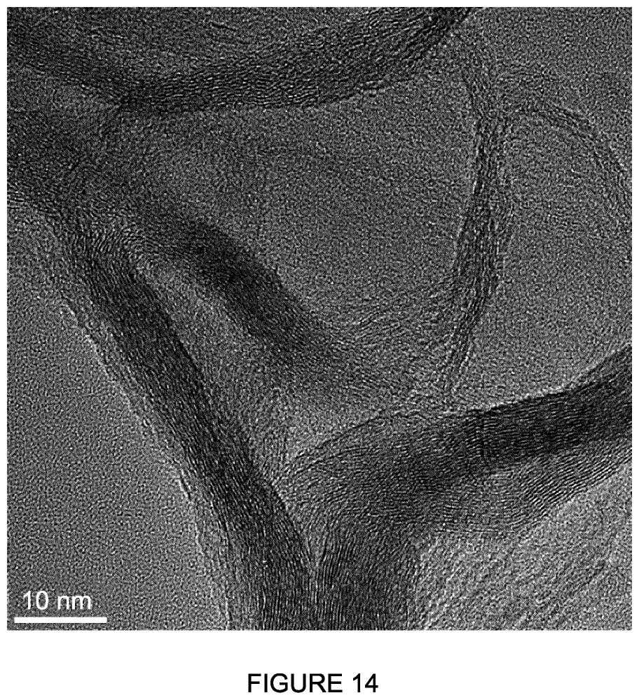

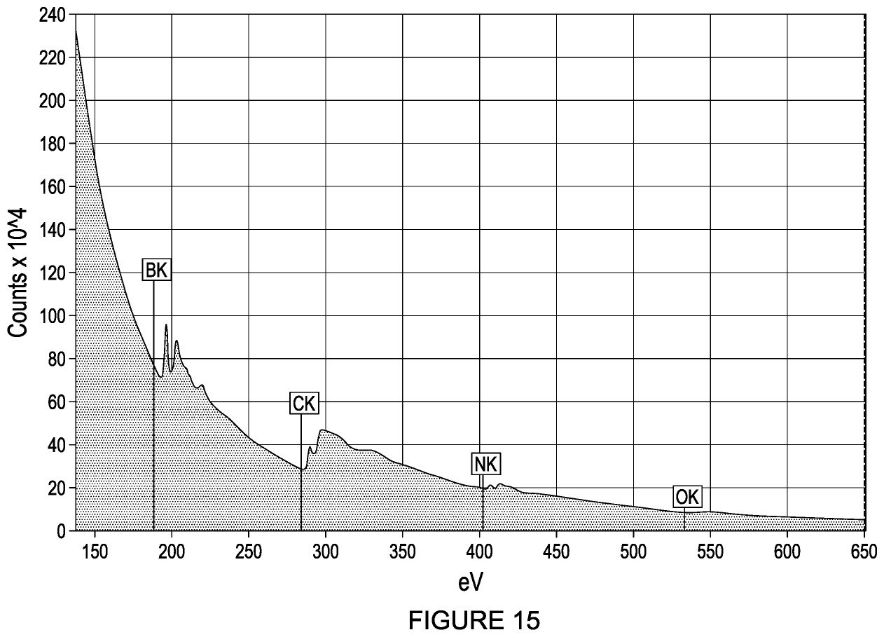

The powder was collected from the product collecting plate. The as-collected material contained various solid phases including SC-BNNS, graphene, and carbon particles coated with 2D BNNS. SC-BCNNS was found to form as one of the primary materials. FIG. 12 shows a scanning electron microscopy (SEM) image of SC-BCNNS dispersed on conductive carbon tape (background). The SC-BCNNS appearance is very similar to other 2D structures such as SC-BNNS and graphene. The agglomeration of the flakes made it challenging to precisely measure the 2D lateral sizes, however, they were determined to be in the range of 100-250 nm. The thickness of the atomic sheets stacking averages around 8 nm (15 atomic layers). Low- and high-resolution transmission electron microscopy (TEM) images for SC-BCNNS are shown in FIG. 13 and FIG. 14, respectively.

A high-angle annular dark-field (HAADF) image was taken and elemental mapping was obtained using energy dispersive X-ray spectroscopy (EDX) for the BCNNS structure shown in FIG. 13. Carbon, nitrogen and boron elements were found to be well dispersed and intermixed throughout the observed structure. It was also determined that these three elements were present in various abundances. The HAADF and EDX analysis suggest the presence of the three B, C and N elements in the structure, which had a varying stoichiometry depending on the point of analysis. FIG. 14 shows that the layer stacking do not show as strong uniformity when compared to SC-BNNS or graphene. These include waviness due to the presence of carbon in the structure. These defects indicate that the material is not pure SC-BNNS but a SC-BNNS-like structure including carbon atoms that slightly modify the local interplanar distances. The well organized planar organization still justifies the single crystalline structure characterizing these SC-BCNNS.

The chemical composition of the BCN nanosheets was further characterized using electron energy loss spectroscopy (EELS). The EELS spectrum is presented in FIG. 5 and shows the detection of the K-edge bands for the boron, carbon and nitrogen at about 190, 285, and 400 eV, respectively. The three bands are composed of the π* and σ* peaks at each core-edge, this being typical for sp²-bonded hexagonal BCN networks. These findings suggest that SC-BNNS and graphene are in-plane hybridized in the nanodomains forming SC-BCNNS. The EELS spectrum shows the detection of a band for oxygen below 550 eV. This is originating from the TEM grid which contains silicon oxide support material.

In conclusion, the present example therefore demonstrated a bottom-up synthesis route for boron carbon nitride nanosheets (BCNNS). The material was generated using radio frequency inductively coupled plasma using ammonia borane, nitrogen, and methane. The scanning and transmission electron microscopy images clearly showed two-dimensional structures with slightly non-uniform layer stacking that is not characteristic to SC-BNNS or graphene. The presence of in-plane dislocation line defects generating the wavy structure in FIG. 14 might be associated with tendency of boron-nitride and carbon-carbon phases to segregate, this being a strong indication that the generated material is indeed SC-BCNNS that incorporates carbon atoms in a regular pattern. Further, the energy dispersive X-ray spectroscopy suggested the varying ratios of the three elements that comprise SC-BCNNS. The presence of these elements as well as the sp² hybridization of the bonding are confirmed using electron energy loss spectroscopy. The SC-BCNNS were produced using the same bottom-up approach used for generating SC-BNNS using ammonia borane precursor, with the addition in the ICP thermal plasma reactor of methane for the supply of atomic carbon within the synthesis window for the generation of nanosheet structures.

The scope is indicated by the appended claims.

1. A method for producing single crystalline boron nitride nanosheets, comprising:
providing a thermal plasma at a plasma zone of a reaction chamber, the reaction chamber comprising an outlet opposite the plasma zone, a condensation zone and a growth zone downstream of the thermal plasma, wherein gas flows have a laminar flow in the reaction chamber wherein the laminar flow provides a controlled residence time in a nucleation temperature field;
providing a plasma-source gas flow comprising a plasma-source gas for the thermal plasma, and a sheath gas flow at the plasma zone of the reaction chamber comprising nitrogen-containing gas to provide an excess of nitrogen in the reaction chamber;
providing a boron source to the thermal plasma through a probe into the thermal plasma to provide boron; and
reacting the boron with the nitrogen to form the single crystalline boron nitride nanosheets (SC-BNNS), the reaction comprising quenching in the condensation zone followed by two-dimensional nucleation downstream in the growth zone;
wherein a pressure in the reaction chamber is between 20 to 200 kPa.

2. The method according to claim 1, further comprising providing a carbon precursor before the step of reacting to obtain single crystalline boron carbon nitride nanosheets (SC-BCNNS).

3. The method according to claim 2, wherein the carbon precursor is methane.

4. The method according to claim 2, wherein the reaction chamber has a cross sectional surface area that increases downstream from the plasma zone.

5. The method according to claim 3, wherein the reaction chamber has a conical geometry.

6. The method according to claim 2, wherein the reaction chamber is cylindrical and includes peripheral inlets.

7. The method according to claim 2, wherein the boron source is in a solid, liquid, or gaseous state.

8. The method according to claim 2, wherein the probe is a cooled probe.

9. The method according to claim 8, wherein the cooled probe is a water cooled probe.

10. The method according to claim 2, wherein the pressure in the reaction chamber is between 40 to 75 kPa.

11. The method according to claim 2, wherein the pressure in the reaction chamber is between 60 to 64 kPa.

12. The method according to claim 2, further comprising cooling or heating walls of the reaction chamber.

13. The method according to claim 2, wherein the plasma-source gas is selected from the group consisting of Ar, He, Ne, Xe, and N₂.

14. The method according to claim 2, wherein the boron source is selected from the group consisting of ammonia borane, boron particles, boron carbide, boron trioxide, diborane, boron trichloride and boric acid.

15. The method according to claim 2, wherein the thermal plasma is an inductively coupled thermal plasma powered by radio frequency.

16. The method according to claim 2, further comprising the step of modifying a residence time in the reaction chamber to control a lateral size and thickness of the single crystalline boron nitride nanosheets or the single crystalline boron carbon nitride nanosheets.

17. The method according to claim 2, wherein the method is free of any catalyst.

18. The method according to claim 2, wherein the single crystalline boron nitride nanosheets have an atomic B:N ratio of between 0.95:1.05 to 1.05:0.95.

19. The method according to claim 2, wherein the single crystalline boron nitride nanosheets or the single crystalline boron carbon nitride nanosheets have a thickness of between 1 to 50 atomic layers.

20. The method according to claim 2, wherein the single crystalline boron nitride nanosheets or the single crystalline boron carbon nitride nanosheets have a surface area of between 10 to 1500 nm².

21. The method according to claim 2, wherein the single crystalline boron nitride nanosheets or the single crystalline boron carbon nitride nanosheets have a crystallinity of at least 95%.

22. The method according to claim 2, wherein the nucleation temperature field is between 2000 to 5000 K.

23. The method according to claim 2, wherein the laminar flow is a laminar flow expansion.
